(19) United States
(12) Patent Application Publication
(10) Pub. No.: US 2005/0173936 A1
(43) Pub. Date: Aug. 11, 2005

(54) Food utensil

(76) Inventor: Karen I. Lewis, Deerfield, IL (US)

Correspondence Address: FRASER MARTIN BUCHANAN MILLER LLC, 132C WEST SECOND STREET, PERRYSBURG, OH, 43551-1401, US

(21) Appl. No.: 11/053,614

(22) Filed: Feb. 8, 2005

Related U.S. Application Data
(60) Provisional application No. 60/543,224, filed on Feb. 10, 2004.

(51) Int. Cl. A47J 43/28

(52) U.S. Cl. 294/7

(57) ABSTRACT

A kitchen utensil comprising a blade and a handle that extends away from the blade at an angle.

### CROSS-REFERENCE TO RELATED APPLICATIONS

This application claims priority to U.S. Provisional Application Ser. No. 60/543,224, filed on Feb. 10, 2004.

### FIELD OF THE INVENTION

The present invention relates to utensils useful in the preparation and/or handling of food. More particularly, the invention relates to a spatula that can be used for spreading batter or other food-related matter in a pan.

### BACKGROUND OF THE INVENTION

The use of kitchen utensils to spread batter and other food-related matter in pans is known in the art. Various spatulas with various shapes and configurations are available for this purpose. Examples of prior art spatulas include those described in U.S. Pat. No. 5,794,996 to Mohabir and U.S. Pat. No. 6,247,736 to Esterson et al.

While the prior art contains several examples of spatulas and other kitchen utensils, a need remains for an improved spatula.

### SUMMARY OF THE INVENTION

The present invention provides a spatula that includes a blade with first and second ends. The first end includes a curvilinear portion, and the second end includes a portion that is substantially linear. A handle extends away from the blade and is connected to the blade at the second end. The handle projects away from the blade at an angle of between about 90° and about 145°, inclusively. In a first exemplary embodiment, the handle extends away from the blade at an angle of between about 125° and about 145°. In a second embodiment, the handle extends away from the blade at an angle of about 135°. In a third embodiment, a first portion of the handle extends away from the blade at an angle between about 90° and about 145° and a second portion curves away from the first portion and blade at an angle greater than the angle the first portion extends from the blade. Further, a curvilinear handle can advantageously be used.

The handle and blade have relative dimensions that make the spatula particularly well suited for use with baking pans that include structural obstacles on their interior and/or exterior, such as bundt pans.

### BRIEF DESCRIPTION OF THE DRAWINGS

FIG. 1 is a perspective view of a spatula according to one embodiment of the invention.

FIG. 2 is a side view of the spatula illustrated in FIG. 1.

FIG. 3 is a top view of the spatula illustrated in FIG. 1.

FIG. 4 is a side view of a spatula according to a second embodiment of the invention.

FIG. 5 is a side view of a spatula according to a third embodiment of the invention.

FIG. 6 is a perspective view of a spatula according to a fourth embodiment of the invention.

FIG. 7 is a perspective view of a spatula according to a fifth embodiment of the invention.

FIG. 8 is a perspective view of a spatula according to a sixth embodiment of the invention.

### DETAILED DESCRIPTION OF EMBODIMENTS OF THE INVENTION

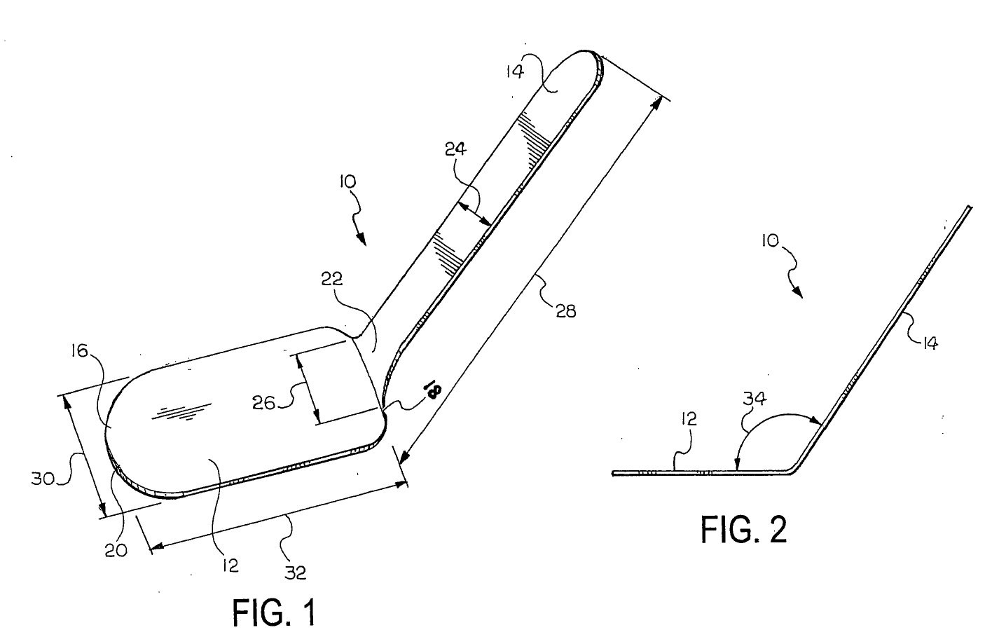

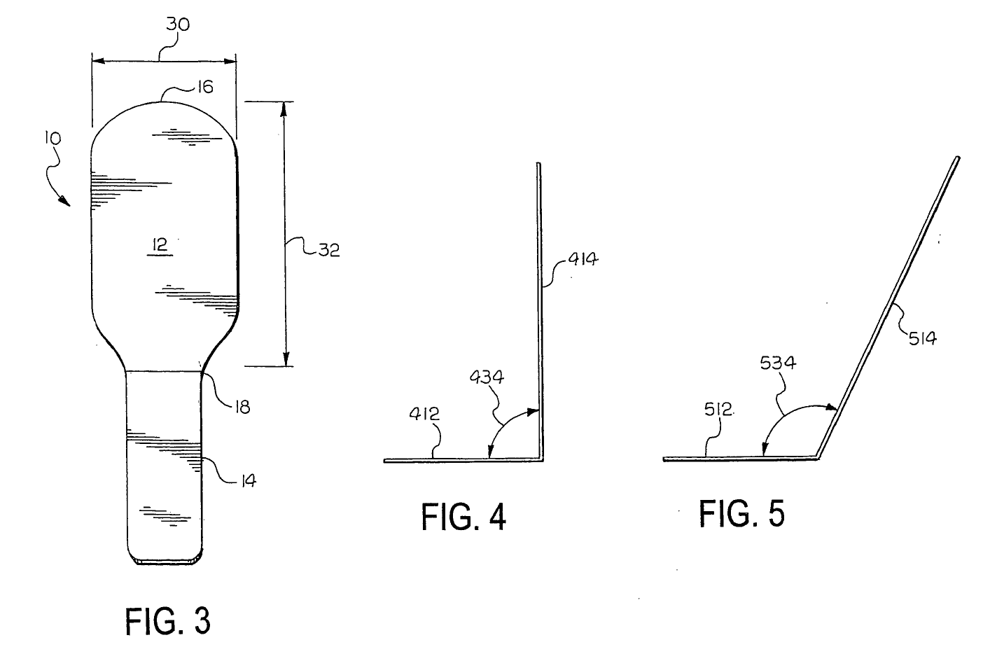

FIGS. 1, 2 and 3 illustrate a spatula 10 according to a first embodiment of the invention. The spatula 10 comprises a blade 12 and a handle 14. The blade includes first 16 and second 18 ends. The first end 16 has a curvilinear portion 20 and the second end 18 includes a portion 22 that is substantially linear.

The handle 14 extends away from the blade 12 and is connected to the blade 12 at the second end 18. The handle 14 can be integrally formed with blade 12 or can be a separately attached member. The handle 14 has a width 24 that can be approximately equal to a length 26 of the linear portion 22 of the second end 18 of the blade 12. The width 24 of the handle can also be, though, less than or greater than the length 26 of the linear portion 22. The handle 14 can have an angulated edge or a rounded edge. A rounded edge may provide a desirable level of comfort to a user of the spatula 10.

The handle 14 has a length 28 that can be between about one and five times the width 30 of the blade 12 at its widest point. As used herein, the width 30 of the blade 12 refers to a dimension measured along an axis that is angulated with a lengthwise axis of the blade 12 extending from the first end 16 to the second end 18. In one embodiment, the length 28 of the handle 14 is between about three and five times the width 30 of the blade 12 at its widest point. In another embodiment, the length 28 of the handle is about 3.4 times the width 30 of the blade 12 at its widest point. In this embodiment, a handle length 28 of about six inches and a blade width 30 of approximately 1.75 inches are suitable.

The length 28 of the handle 14 can also be between about two and five times the length 32 of the blade 12. As used herein, the length 32 of the blade 12 refers to a dimension of the blade 12 measured along an axis that extends from the first end 16 to the second end 18. In one embodiment, the length 28 of the handle 14 is between about two and about three times the length 32 of the blade 12. In one embodiment, the length 28 of the handle 14 is about 2.4 times the length 32 of the blade. In this embodiment, a handle length 28 of about six inches and a blade length 32 of about 2.5 inches are suitable.

In one embodiment of the invention, the length 28 of the handle 14 is between about three and about four times the width 30 of the blade 12 at its widest point and between about two and about three times the length 32 of the blade 12.

The handle 14 extends away from the blade 12 at an angle 34 that is between about 90° and about 145°. The handle 14 can extend away from the blade 12 at an angle 34 that is between about 125° and 145°. In the embodiment illustrated in FIGS. 1 through 3, the handle 14 extends away from the blade 12 at an angle 34 of about 135°. In a second embodiment, illustrated in FIG. 4, the handle 414 extends away from the blade 412 at an angle 434 of about 90°. In third embodiment, illustrated in FIG. 5, the handle 514 extends away from the blade 512 at an angle 534 of approximately 115°.

The inventor has determined that the angle 34 and relative dimensions of the lo handle 14 and blade 12 make the spatula 10 particularly well-suited for use with baking pans that include structural obstacles on their interior and/or exterior, such as bundt pans. A spatula 10 according to the invention that is particularly well-suited for such uses includes a handle 14 that has a length of about six inches. In this embodiment, the blade 12 has a length of about 2.5 inches and a width of about 1.75 inches at the widest point of the blade 12. Also in this embodiment, the handle 14 extends away from the blade 12 at an angle 34 of about 135°.

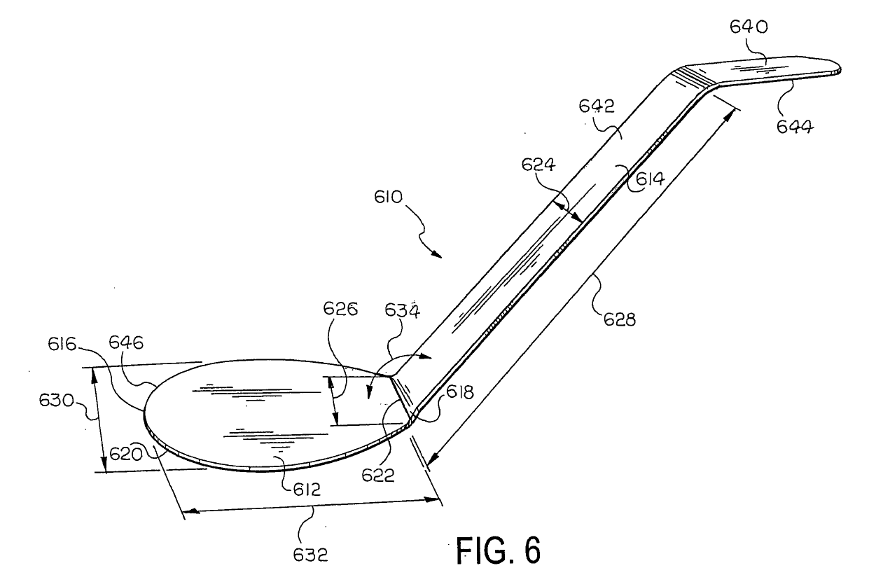

FIG. 6 illustrates a spatula 610 according to a fourth embodiment of the invention. The spatula 610 of this embodiment is similar to the spatula 10 of the embodiment illustrated in FIGS. 1 through 3, except as detailed below. Accordingly, the spatula 610 includes a blade 612 and a handle 614. The blade 612 includes first 616 and second 618 ends. The first end 616 has a curvilinear portion 620 and the second end 618 includes a portion 622 that is substantially linear. The handle 614 extends away from the blade 612 and is connected to the blade 612 at the second end 618.

An angle 634 at which the handle 614 extends away from the blade 612 is similar to the angle 34 for the embodiment illustrated in FIGS. 1 through 3. Also, the relative dimensions of the handle 614 and blade 612 are similar to those described for the embodiment illustrated in FIGS. 1 through 3.

The handle 614 in this embodiment includes a tab portion 640 that extends away from a main body 642 of the handle 614. In one embodiment, the tab portion 640 lies in a plane that is substantially parallel to a plane in which the blade 612 lies. The tab portion 640 can be integrally formed with the main body 642 of the handle 614 or can comprise a separately attached member. The tab portion 640 provides a surface 644 that can be rested against another surface, such as a hand of a user or a storage rack, during use or storage. Further, in combination with the desired angles 634 and relative dimensions of the handle 614 and blade 612, the tab portion 640 provides structural features to the spatula 610 that provide comfort during repeated and/or prolonged use.

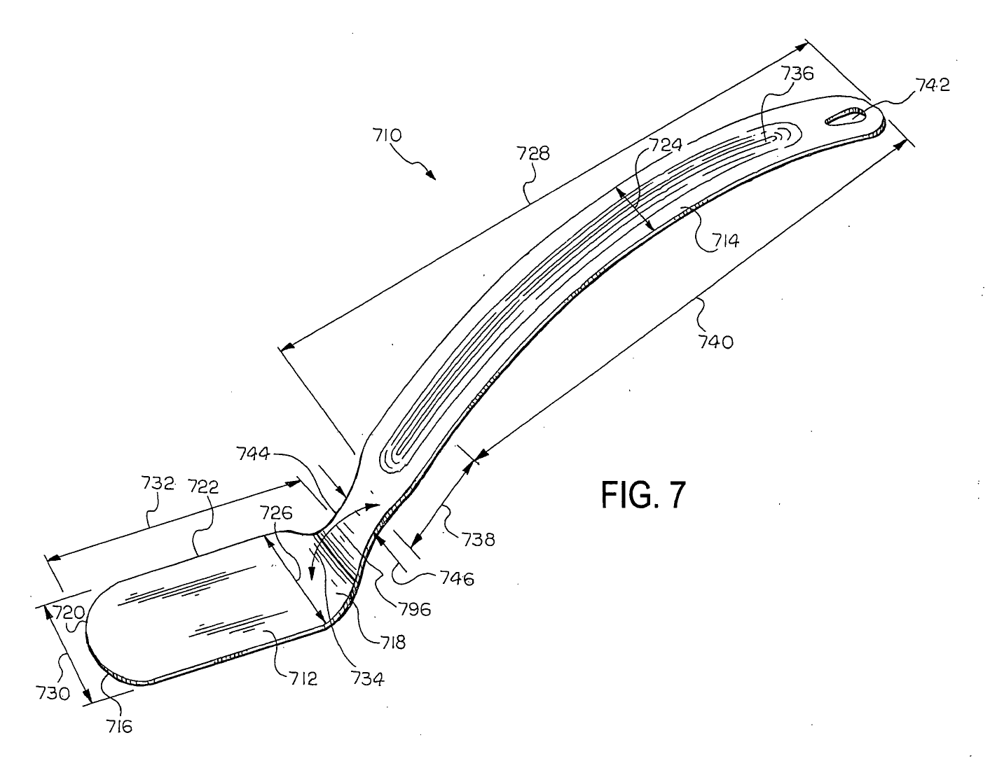

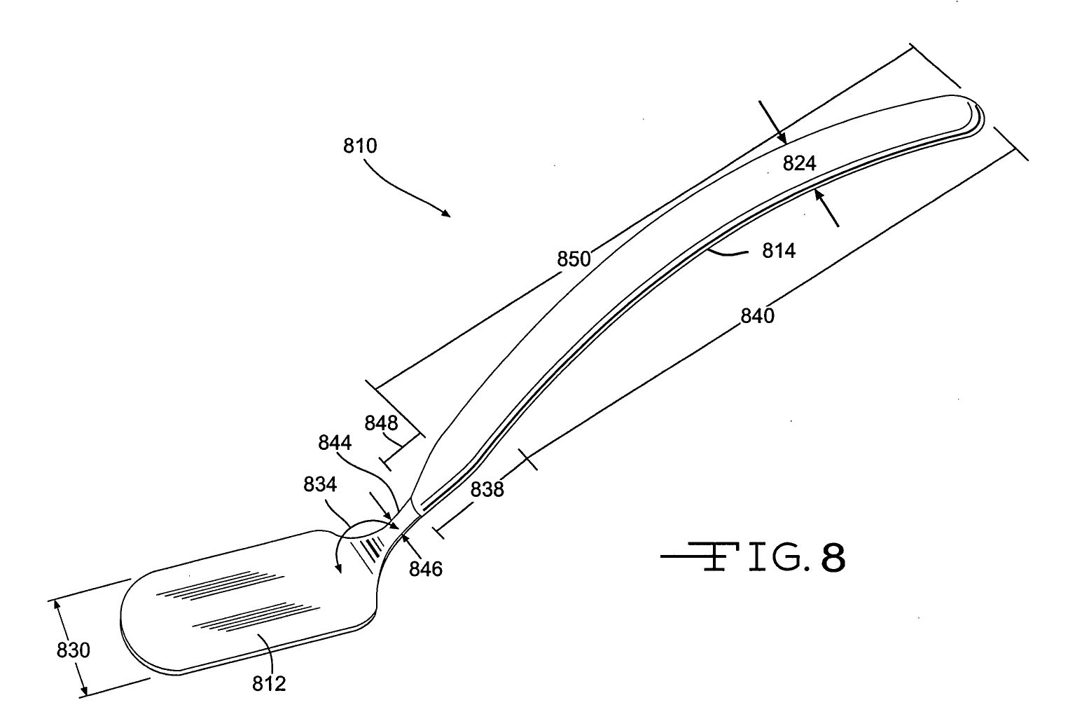

FIG. 7 illustrates a spatula 710 according to a fifth embodiment of the invention. The spatula 710 of this embodiment is similar to the spatula 10 of the embodiment illustrated in FIGS. 1 through 3, except as detailed below. A first portion 738 of the handle 714 extends away from the blade 712 at an angle 734 between about 90° and about 145° and a second portion 740 curves away from the first portion 738 and blade 712 at an angle greater than the angle the first portion 738 extends away from the blade 712. Further, the handle 714 comprises a loop 742 at the end of the handle 714 farthest from the blade 712 and a gusset 736 on the handle 714. The gusset 736 strengthens the handle 714 when manufactured from stainless steel as well as providing ergonomic benefits. Also the blade 712 is connected to the handle 714 by a neck 744. The neck 744 has a width 746 smaller than both the width 724 of the handle 714 and the width 730 of the blade 714.

FIG. 8 illustrates a spatula 810 according to a sixth embodiment of the invention. The spatula 810 of this embodiment is similar to the spatula 710 of the embodiment illustrated in FIGS. 1 through 3, except as detailed below. A first portion 838 of the handle 814 extends away from the blade 812 at an angle 834 between about 90° and about 145° and a second portion 840 curves away from the first portion 838 and blade 812 at an angle greater than the angle the first portion 838 extends away from the blade 812. Further, the blade 812 is connected to the handle 814 by a neck 844. The neck 844 has a width 846 smaller than both the width 824 of the handle 814 and the width 830 of the blade 814. The handle 814 is substantially ovoid in cross-sectional shape. It is noted that the handle 814 can have any suitable cross-sectional shape. Examples of alternative cross-sectional shapes include circular, rectangular, and kidney cross-sectional shapes. Cross-sectional shapes that provide a substantially rounded circumference are considered advantageous at least because they increase comfort during use. Further, the blade 812 is manufactured from stainless steel while the handle 814 is manufactured of any suitable material other than stainless steel, such as nylon, wood, polytetrafluoroethylene, polycarbonate, and other plastics and/or resins. The handle 814 is attached to the blade 812 at the neck 844. A portion 848 of the handle 814 has substantially the same width 846 of the neck 844 and tapers to the width 824 of the remaining portion 850 of the handle 814.

Spatulas according to the invention can be made of any appropriate material or materials. Examples of suitable materials include stainless steel, nylon, wood, polytetrafluoroethylene, polycarbonate, and other plastics and/or resins. Stainless steel is particularly well-suited for use in the present invention due to its well-characterized nature and acceptance as a suitable material for food-related utensils. Further, stainless steel facilitates manufacturing of the spatulas of the invention, as described below. 18/10 stainless steel, which is commonly used in food utensils, is an example of a suitable stainless steel for use in the spatulas of the invention.

The spatulas of the present invention can be manufactured by any appropriate method, and the specific method selected may depend on the material(s) chosen. Examples of suitable methods include injection molding and stamping techniques. In one embodiment of the invention, a spatula is formed of a single piece of stainless steel. The spatula of this embodiment can be manufactured by stamping a flat-stock master piece from a flat piece of stainless steel, and then bending or rolling the handle to the appropriate angle. Also, if a tab portion 640 is desired (as illustrated in FIG. 6), a further bending or rolling step can be applied to extend the tab portion 640 away from the main body 642 of the handle 614 at the appropriate angle 634.

The use of plastic materials of construction and injection molding processes yields certain advantages that manufacturing with stainless steel does not. For example, injection molding allows the edges to be rounded rather than flat, and the handle may take any shape desired such as round, substantially flat with rounded edges, and ovoid in shape.

The preceding detailed description and appended drawings describe and illustrate various embodiments of the invention. They are intended solely to teach a person of ordinary skill in the art to make and use the invention, and are not intended to limit the scope of the invention in any manner. The various embodiments are merely examples of combinations of the features of the invention. Any combination of the features may be used to create additional embodiments.

1. A spatula, comprising:
a blade having a first end comprising a curvilinear portion, a second end comprising a linear portion, a blade length extending from the first end to the second end;
a handle connected to the linear portion of the second end and extending away from the blade at an angle, the handle having a handle length;
wherein the handle length is between about two and about five times the blade length; and
wherein the angle is between about 90° and about 145°.

2. A spatula according to claim 1, wherein the handle is curvelinear.

3. A spatula according to claim 2, wherein the handle comprises a gusset.

4. A spatula according to claim 2, wherein the handle has first and second portions, wherein the first portion of the handle extending away from the blade at an angle between about 90° and about 145° and the second portion curving away from the first portion and blade at an angle greater than the angle the first portion extends from the blade.

5. A spatula according to claim 1, wherein the handle comprises a loop.

6. A spatula according to claim 1, wherein the blade is connected to the handle by a neck having a width less than the handle width and blade width.

7. A spatula according to claim 1, wherein the spatula is formed of stainless steel.

8. A spatula according to claim 1, wherein the spatula is formed of wood.

9. A spatula according to claim 1, wherein the spatula is formed of a plastic selected from the group consisting of polytetrafluoroethylene, polycarbonate, and nylon.

10. A spatula, comprising:
a blade having a first end comprising a curvilinear portion, a second end comprising a linear portion, a blade length extending from the first end to the second end;
a neck having a width less than the width of said blade and connecting the linear portion of the second end and extending away from the blade at an angle to the handle, the handle having a handle length and width greater than the width of the neck;
wherein the handle is curvelinear and has a handle length between about two and about five times the blade length; and
wherein the angle is between about 90° and about 145°.

11. A spatula according to claim 10, wherein the handle comprises a gusset.

12. A spatula according to claim 10, wherein the handle comprises a loop.

13. A spatula according to claim 10, wherein the handle has first and second portions, the first portion of the handle extending away from the blade at an angle between about 90° and about 145° and the second portion curving away from the first portion and blade at an angle greater than the angle the first portion extends from the blade.

14. A spatula according to claim 10, wherein the spatula is formed of stainless steel.

15. A spatula according to claim 10, wherein the spatula is formed of wood.

16. A spatula according to claim 10, wherein the spatula is formed of a plastic selected from the group consisting of polytetrafluoroethylene, polycarbonate, and nylon.
